(19) United States
(12) Patent Application Publication
(10) Pub. No.: US 2008/0109502 A1
(43) Pub. Date: May 8, 2008

(54) Method And Apparatus For Partitioning Of A Bitstream

(76) Inventor: Benjamin Aaron Gittins, Woodford (AU)

Correspondence Address: Christopher J. McDonald;Hoffman, Wasson & Gitler, 2461 South Clark Street, Suite 522, Arlington, VA, 22202, US

(21) Appl. No.: 11/664,263

(22) PCT Filed: Sep. 29, 2005
(86) PCT No.: PCT/AU05/01492

§ 371 Date: Mar. 30, 2007

(30) Foreign Application Priority Data
Sep. 30, 2004 (AU) 2004905639

(51) Int. Cl. G06F 7/58

(52) U.S. Cl. 708/250

(57) ABSTRACT

Apparatus for encoding and deciphering inter-chip signals has a single pseudo-random number generator (PRNG) (31, 41, 42) which generates a single pseudo-random number stream. A decision making module (32, 43) creates two pseudo-random number streams from the output of the PRNG (31, 41, 42). Buffers (33, 35, 37, 44, 45) buffer pseudo-random number streams.

### FIELD OF THE INVENTION

The present invention relates to the generation of pseudo-random bitstreams.

### BACKGROUND OF THE INVENTION

Apparatus which is used for generating a pseudo-random stream is generally referred to as ‘pseudo-random number generator’ (PRNG). Throughout this specification, including the claims, the term ‘PRNG’ is used to refer to any pseudo-random number generator. The encoding operations which use PRNGs may be performed at any of the bit, byte, or block levels and so the bits in a pseudo-random ‘bitstream’ may occur a single bit at a time, a byte at a time, or in other groupings of bits. The creation of such bits, bytes, or other groupings of bits is generally performed synchronously with the receipt of the data to be encoded or decoded, that is, within a clock cycle of particular hardware, or spaced by sub-multiples or multiples of a clock cycle. Throughout this specification, including the claims, the term ‘bitstream’ is used as comprising all these groupings of bits, whether delivered synchronously or asynchronously.

Methodologies for generating pseudo-random streams are well known and are summarized, for example, in chapter 16 the book Applied Cryptography: Protocols, Algorithms, and Source Code in C, by Bruce Schneier, 2^{nd} edition, (1996), ISBN 0-471-12845-7. Linear feedback shift registers (LFSRs) are typical, simple PRNGs. An LFSR is a shift register in which the bits in the register move down the register to an output point, while a feedback function feeds bits sequentially into the register. The feedback function is typically an XORing together of the bits from pre-selected positions along the length of the shift register. An LFSR, like all ‘pseudo random’ number generators, is not genuinely random in that it has a periodicity according to which the stream of bits out of it repeats cyclically. In general, the larger the LFSR (that is, the larger the number of register cells which it contains) the longer will be the period before its output starts to repeat a cycle. There are PRNGs which are more sophisticated than LFSRs. These include, but are not limited to, hashing functions, stream ciphers such as derivatives of LFSR constructions, and counter mode of operation for block ciphers.

In the context of placing PRNGs on integrated circuit chips to inhibit reverse-engineering based on an analysis of inter-chip signals there are a number of considerations. It is desirable that the PRNG occupies a small circuit area and have low power consumption. The PRNG needs to operate at high speed to match the speed of communications between chips. A modest to high level of security is needed, which requires circuit area to store private state.

FIG. 1 illustrates a seeded PRNG 1 operating in accordance with the prior art. The PRNG 1 generates an output 3. The output 3 is in turn applied in a block chaining function 5 against the plaintext 4 which is received from a source 2. The encoded output of 5 is passed over channel 6 and becomes input to a inverse block chaining function 7. The inverse block chaining function 7 also takes as an input the synchronized output 9 of the PRNG 8. The PRNG 8 is seeded, that is initialized, identically to PRNG 1. The output 10 of the inverse block chaining function is the same as the plaintext 4. Plaintext 10 is passed to the recipient 11.

FIG. 2 illustrates a clock-cycle accurate instance of FIG. 1 according to the prior art. FIG. 2 shows a seeded PRNG 1, generating one unit 12 of output every clock cycle. In each clock cycle, the output 12 of the PRNG is applied in a block chaining function 5 against the plaintext 15. The plaintext 14 is generated and moves to plaintext 15 every clock cycle. The output of block chaining function 5 is output as 16 in the next clock cycle, and subsequently to the positions such as is shown at 17 in consecutive clock cycles. An undetermined number of clock-cycles will pass before output 16 arrives as the input 19 of inverse block chaining function 7. In this manner it can be seen that a value 16 is transported between two chips suffering wire-latency of 0 (zero) to n clock-cycles. The inverse block chaining function 7 also takes as input the synchronized output of PRNG 8 which has been seeded identically to PRNG 1. The output plaintext 20 is accordingly identical in value to the plaintext 14. FIG. 2 illustrates that in a physical implementation the output of block chaining function 5 typically incurs significant wire-latency delays before arriving at inverse block chaining function 7.

FIG. 3 illustrates the difficulties that would arise in attempting to use a singular PRNG for the purposes of both encoding and decoding. The labels 1 through 20 found in FIG. 3 are identical to labels 1 through 20 in FIG. 2. FIG. 3 shows a new plaintext message 21 to be encoded travelling from right to left. The message plaintext value 21 is passed into block chaining function 28 that also takes as an input the output of the PRNG 8. The output 23 of block chaining function 28 incurs latency of 0 (zero) to n clock-cycles over communications media 18 before arriving as input to inverse block chaining function 27. The latency as highlighted in 29 is important because it determines the phase adjustment between the two transmitting circuits.

FIG. 3 illustrates the journey of input 21 through 23 before arriving at 25. If in this example only 2 clock cycles pass, the input to 25 is phase offset by 2 clocks. FIG. 3 illustrates that the PRNG 1 generates output every clock cycle that is passed as input to inverse block chaining function 27. It is clear that a two clock cycle phase difference in the inputs between the output of PRNG 1 and the value 25 will result in an incorrect decoding of the encoded message.

### SUMMARY OF THE INVENTION

In one aspect, the present invention accordingly provides a process of encoding digital inputs comprising:
receiving n inputs, the n inputs comprising:
   at least one ingress input; and
   at least one egress input,
generating a first pseudo-random bitstream;
from the first pseudo-random bitstream, generating n further pseudo-random bitstreams;
inputting each of at least (n−1) of the n further pseudo-random bitstreams into one of (n−1) FIFO buffers, each of which (n−1) FIFO buffers releases stored data as output on demand;
encoding the ingress inputs and the egress inputs to produce respectively encoded ingress outputs and encoded egress outputs, the encoding comprising:
   for each of (n−1) of the inputs, using output from a unique one of the (n−1) FIFO buffers in the encoding; and
   for one of the inputs other than the (n−1) inputs, using in the encoding a pseudo-random bitstream which is:
      either the n^{th} further pseudo-random bitstream; or
      the output of an n^{th} FIFO buffer, the input to which is the n^{th} further pseudo-random bitstream.

In another aspect, the present invention provides apparatus for encoding n inputs, the n inputs comprising:
at least one ingress input; and
at least one egress input,
the apparatus comprising:
   a pseudo-random number generator (PRNG);
   a bit-stream generator which takes the output of the PRNG as its input and which generates ii further pseudo-random bitstreams as its outputs;
   (n−1) FIFO buffers, each of which (n−1) FIFO buffers takes as its input one of the (n−1) further pseudo-random bitstreams and which releases stored data as output on demand;
   n encoders, each of which encodes one of the n inputs and which uses in the process of encoding:
      for each of (n−1) of the inputs, output from a unique one of the (n−1) FIFO buffers; and
      for one of the inputs other than the (n−1) inputs, a pseudo-random bitstream which is:
         either the n^{th} further pseudo-random bitstream; or
         the output of an n^{th} FIFO buffer, the input to which is the n^{th} further pseudo-random bitstream.

Further aspects of the invention are summarized in the patent claims which appear at the end of this specification.

It will accordingly be seen that according to some embodiments of the present invention a single PRNG can be placed on an IC chip to achieve the same functionality as would be achieved by placing two PRNGs on the same chip. This allows the single PRNG of the embodiments of the present invention to occupy similar surface area as would two separate PRNGs. A result is that the single, larger, PRNG normally will result in higher security than would two separate, smaller, PRNGs. More importantly a small additional increase in area can be used to increase the strength of a singular PRNG exponentially more than would the division of the same increase of area across two PRNGs.

### BRIEF DESCRIPTION OF THE DRAWINGS

Preferred embodiments of the invention are described below with reference to the following drawings in which:

FIGS. 1 and 2 illustrate prior art;

FIG. 3 illustrates a difficulty of the prior art; and

FIGS. 4 to 8 illustrate preferred embodiments of the present invention.

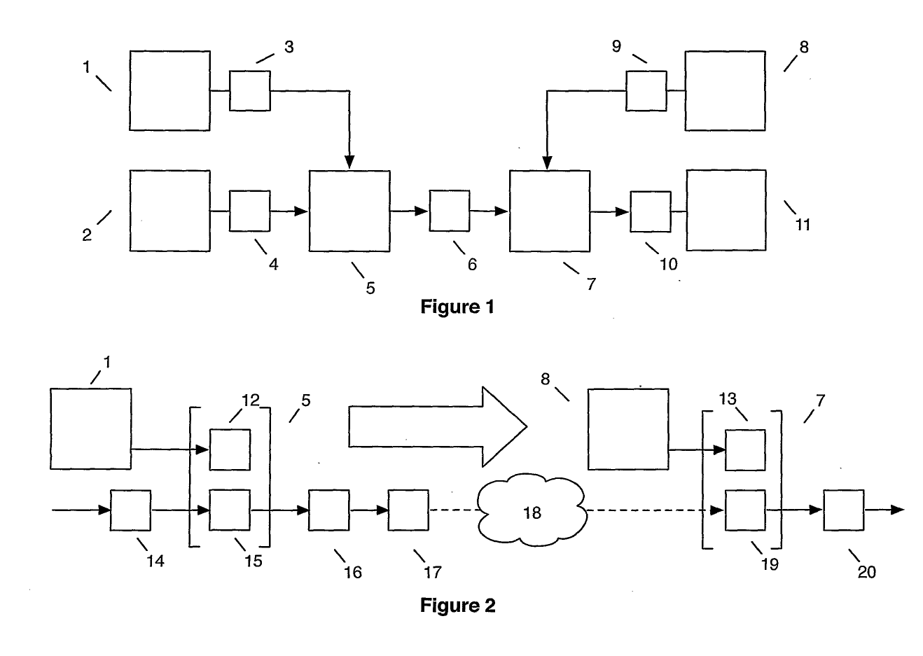

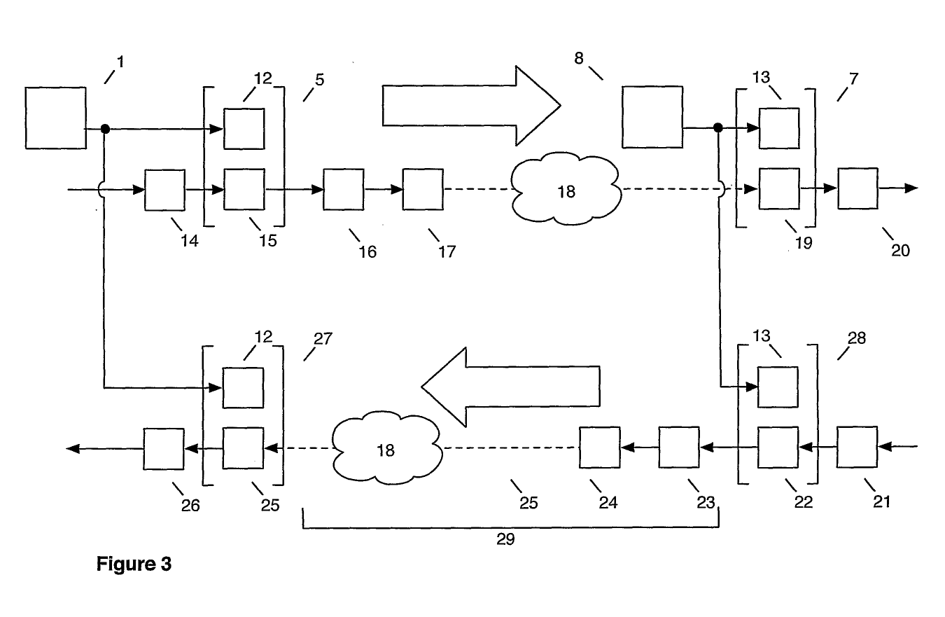

### DESCRIPTION OF PREFERRED EMBODIMENTS OF THE INVENTION

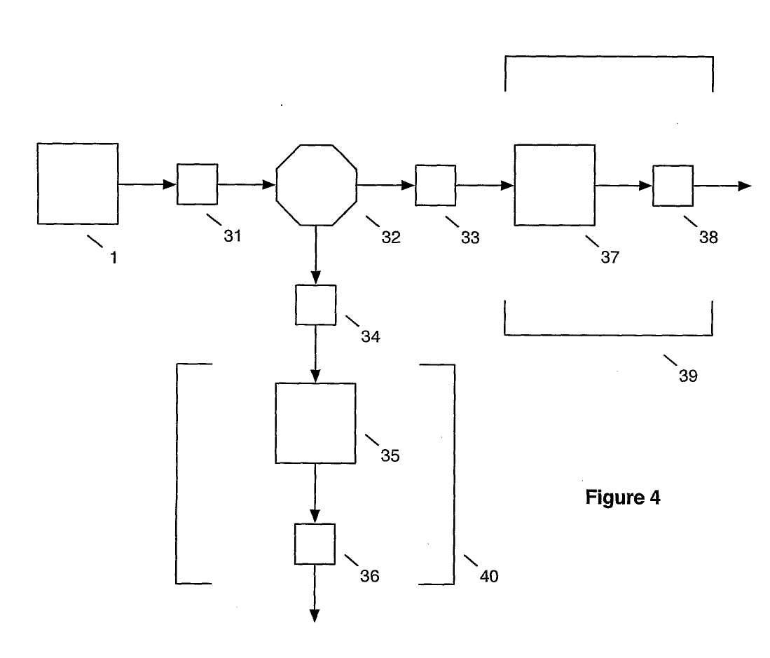

FIG. 4 illustrates a preferred embodiment of the present invention. In FIG. 4 a PRNG 1 generates an output 31 which serves as input to decision making module 32. For the purpose of the presently described embodiments of the invention the PRNG releases a bit at a time, or multiple bits at a time in parallel. The PRNG may perform work for several clock cycles before releasing output, as may be found in a hashing function, or in a block-cipher.

The decision making module 32 has two output terminals from which alternative outputs 33 and 34 are generated. Output 33 from decision module 32 is connected to a buffering module 37 which in turn has an output 38. Similarly output 34 from decision making module 32 is connected to buffering module 35 which has an output 36.

The decision module 32 of FIG. 4 has the following options.
(1) To duplicate the input 31 as output 33 and 34. That is, outputs 33 and 34 are identical to each other and to input 31.
(2) To alternate the input 31 every clock cycle between 33 and 34, ensuring no duplication of bit material. In one preferred embodiment, for one clock cycle the input 31 is distributed to the output 33 and in the next clock cycle the input 31 is distributed to the output 34, such that the input port to the FIFO buffer is wider than its output port.
(3) To divide the input 31 between outputs 33 and 34 within each clock cycle.

For example, dividing across the width of the input bitstream 31 so that high bits are distributed to one of the outputs 33 and 34 and so that the low bits are distributed to the other of the outputs 33 and 34.

The option (1) duplicates the PRNG output. Options (2) and (3) ensure the PRNG output is uniquely distributed between two subsequent channels.

The FIFO buffer module 37 always has its read and write circuitry enabled independently. That is, an input to the buffer does not necessitate an output from the buffer and the drawing of an output from the buffer is not necessarily depended on the synchronized receipt of an input by the buffer

Throughout this specification, including the claims:
the term ‘asynchronous FIFO buffer’ is used to refer to a FIFO buffer as referred to in the preceding paragraph, where the read and write circuitry are independently clocked; and
‘synchronous FIFO buffer’ is used to refer to a FIFO buffer where the read and write circuitry share a common clock.

According to other preferred embodiments, the asynchronous FIFO buffer 37 input and output ports are of different widths enabling the PRNG to operate at integral multiples higher or lower to the output. For example, an 8 bit input at 300 MHz can be released as a 16 bit output at 150 MHz. In the present arts, the term ‘FIFO buffer’ is the term which is generally used in referring to hardware which implements FIFO functionality and the term ‘FIFO queue’ is the term which is generally used when referring to software implementations of FIFO functionality, although it is also common to use either term to refer to either hardware or software implementation. Throughout this specification, including the claims, we use the term ‘FIFO buffer’ as comprising both hardware and software implementations of FIFO functionality.

Similarly in FIG. 4 the first-in-first-out buffer module 35 takes as its input the pseudo-random stream 34. The asynchronous FIFO buffer module 35 releases its contents asynchronously as the output 36. Again in other preferred embodiments the asynchronous FIFO buffer 35 has input and output ports which are of different widths.

In FIG. 4 the read operations of asynchronous FIFO buffers 37 and 35 are also independent. That is, the read operation performed on 37 is entirely independent of the read operation performed on 35. In this manner the output of a singular stream is asynchronously and independently read.

According to further preferred embodiments of the invention which are not illustrated in FIG. 4, a decision making module such as module 32 of FIG. 4 has more than two outputs, such that a pseudo-random input stream such as stream 31 of FIG. 4 is distributed to more than two output streams, preferably buffered as illustrated and described with reference to FIG. 4.

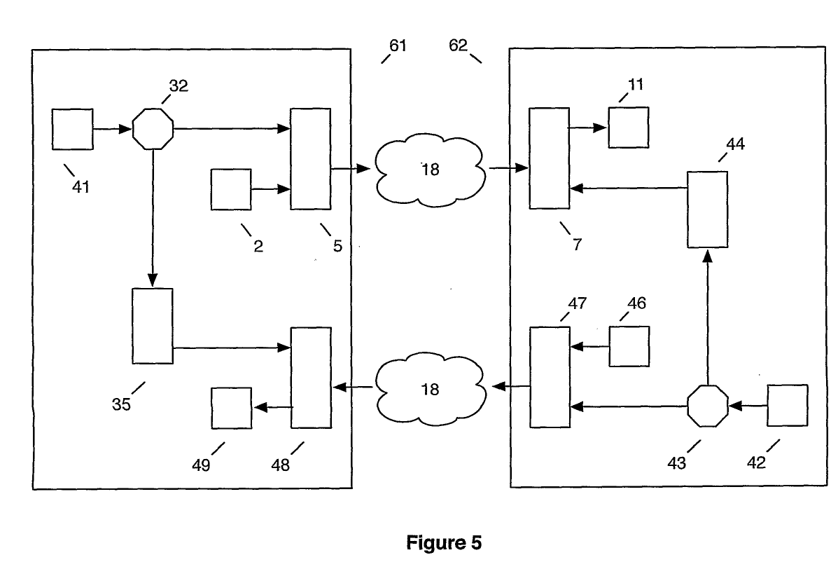

FIG. 5 illustrates further preferred embodiments of the present invention. The embodiment of FIG. 5 includes two identical circuits 61 and 62. The circuit 61 includes a PRNG 41 and a decision making module 32 with one output to a block chaining function 5. The block chaining function 5 also has an input from a source 2. The decision making module has another output to the asynchronous FIFO buffering module 35. The output of the asynchronous FIFO buffering module 35 is input to an inverse block chaining function 48, which also has an input from the communications channel 18 and an output 49. Although circuit 62 has the same contents as does circuit 61, in circuit 62 the reference numbering is different in FIG. 5. The circuit 62 includes a PRNG 42 and a decision making module 43 with one output to a block chaining function 47. The block chaining function 5 also has an input from a source 46. The decision making module has another output to the asynchronous FIFO buffering module 44. The output of the asynchronous FIFO buffering module 44 is input to an inverse block chaining function 7, which also has an input from the communications channel 18 and an output 11.

In the operation of the preferred embodiment of FIG. 5, the PRNGs 41 and 42 are identically seeded and both circuits are enabled at nearly identical times. The PRNG 41 begins generating output that is fed as input to decision circuit 32. The PRNG 42 begins generating output that is fed as input to decision circuit 43. The output of decision circuit 32 fed into block chaining function 5 such that binary identical output of decision circuit 43 is fed into the asynchronous FIFO buffer 44. In the same fashion the alternate output of decision circuit 32 fed into binary asynchronous FIFO buffer 35 such that binary identical output of decision circuit 43 is fed into block chaining function 47.

Over 0 (zero) to n clock-cycles output of decision circuit 32 is stored in the asynchronous FIFO buffer 35 and the output of decision circuit 43 is stored in the asynchronous FIFO buffer 44.

The asynchronous FIFO buffer 35 releases its first valid value and is ready to be applied against the arrival of the output of block chaining function 47 as input to inverse block chaining function 48. The first valid output of the asynchronous FIFO buffer 35 is applied against the first valid output of block chaining function 47 ensuring correct phase alignment resulting in value 42 and 49 matching.

The asynchronous FIFO buffer 44 releases its first valid value and is ready to be applied against the arrival of the output of block chaining function 5 as input to inverse block chaining function 7. The first output of the asynchronous FIFO buffer 44 is applied against the first valid output of block chaining function 5 ensuring correct phase alignment resulting in value 2 and 11 matching.

FIG. 5 accordingly illustrates correct phase adjustments ensuring that a singular PRNG can be used to encode and decode two independent streams of data flow.

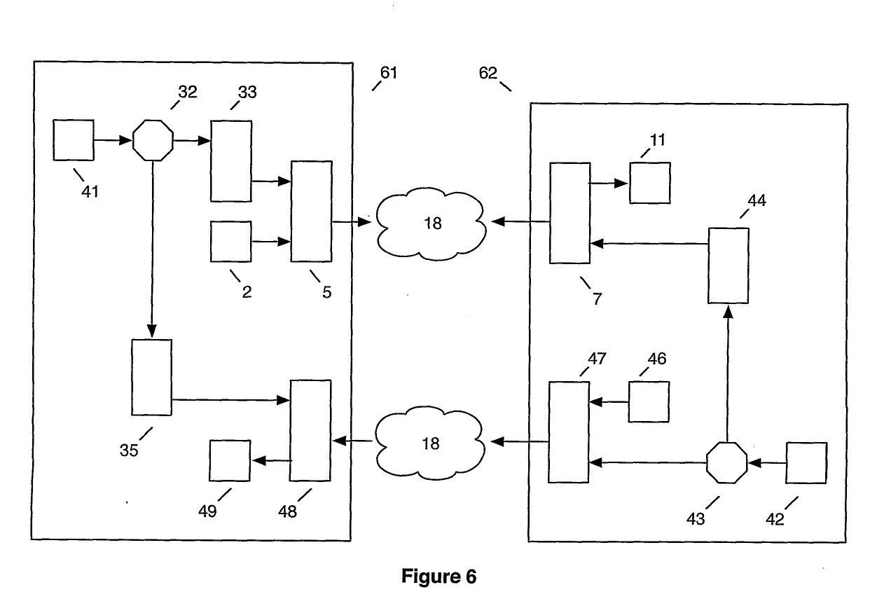

Yet further preferred embodiments of the present invention are illustrated in FIG. 6. FIG. 6 illustrates the addition of two asynchronous FIFO buffers 33 and 45 within circuits 61 and 62 respectively. FIG. 6 shows that buffer 33 takes as its input the output of decision circuit 32 and releases its output on demand as input to block chaining function 5. FIG. 6 also shows that buffer 45 takes as its input the output of decision circuit 43 and 43 and releases its output on demand as input to the block chaining function 47.

FIG. 6 illustrates that the PRNGs 41 and 42 can prime the contents of all the asynchronous FIFO buffers 33, 35, 44 and 45. Priming the asynchronous FIFO buffers increases the tolerance of the circuit to additional phase latencies (such that the first output of block chaining function 5 and block chaining function 47 may be several clock cycles out of phase). Priming is intended only to partially fill the asynchronous FIFO buffer, allowing additional space for block chaining function 5 to operate at differential times to inverse block chaining function 48.

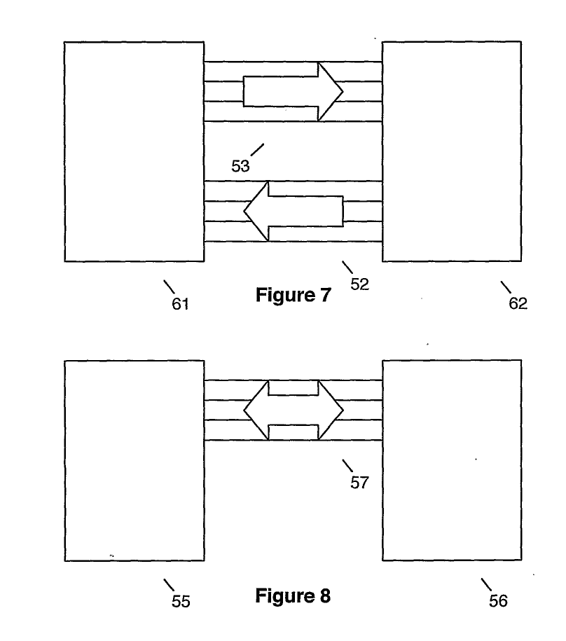

FIG. 7 illustrates embodiments of the invention in which the communications channels which are each identified by reference numeral 18 in FIGS. 5 and 6 are implemented as separate unidirectional buses such as buses 52 and 53.

FIG. 8 illustrates embodiments of the invention in which the communications channels which are each identified by the reference numeral 18 in FIGS. 5 and 6 are implemented as sharing a common bi-directional bus 57. According to the embodiments of the invention which are illustrated in FIG. 8, sharing of one bi-directional bus is implement by using synchronous FIFO buffers 44, 45, 33 and 49. The use of synchronous but independently operated FIFO buffers 33, 35, 44 and 45 such that the bus time-sharing protocol ensures uniform communication in both directions such that the synchronous FIFO buffers have sufficient elements to encode and decode. As a specific example, the preferred embodiment of FIG. 8 may operate such that PRNG 41 generates ten values that are distributed to the synchronous FIFO buffers 33 and 35. Ten values are encoded using block chaining function 5 and arrive as input to block chaining function 7. The I/O drivers rest then change direction and block chaining function 47 demands ten values from the synchronous FIFO buffer 45. The output of block chaining function 47 arrives as input to inverse block chaining function 48. The synchronous FIFO buffer in this specific example would require a minimum of twenty elements.

In the synchronous construction either the block chaining function 5 or 47, or inverse block chaining function 7 or 48 is to be responsible for enabling the PRNG 41 to output another valid value. In this way, one type of operation triggers the generation of new PRNG values; where both operations consume data from their respective FIFO buffers.

A small degree of localized unbalance can be sustained between encode and decode operations, limited by the number of buffers available. In this manner given a equal number of values are encrypted and decrypted within the limits of the available buffered values, a single PRNG can be used to encrypt and decrypt partially asymmetric traffic over bidirectional I/O wires.

‘Comprises/comprising’ when used in this specification is taken to specify the presence of stated features, integers, steps or components but does not preclude the presence or addition of one or more other features, integers, steps, components or groups thereof.

1-48. (canceled)

49. A process of encoding digital inputs comprising:
receiving n inputs, the n inputs comprising:
at least one ingress input; and
at least one egress input,
generating a first pseudo-random bitstream;
from the first pseudo-random bitstream, generating n further pseudo-random bitstreams;
inputting each of at least (n−1) of the n further pseudo-random bitstreams into one of (n−1) FIFO buffers, each of which (n−1) FIFO buffers releases stored data as output on demand;
encoding the ingress inputs and the egress inputs to produce respectively encoded ingress outputs and encoded egress outputs, the encoding comprising:
for each of (n−1) of the inputs, using output from a unique one of the (n−1) FIFO buffers in the encoding; and
for one of the inputs other than the (n−1) inputs, using in the encoding a pseudo-random bitstream which is:
either the n^{th} further pseudo-random bitstream; or
the output of an n^{th} FIFO buffer, the input to which is the n^{th} further pseudo-random bitstream.

50. A process as claimed in claim 49, in which n is greater than 2.

51. A process as claimed in claim 49, in which the first pseudo-random bitstream is at least two bits wide.

52. A process as claimed in claim 49, in which at least two of the n further pseudo-random bitstreams are generated by sequentially distributing the first pseudo-random bitstream to each of at least two of the n further pseudo-random bitstreams.

53. A process as claimed in claim 52, in which the first pseudo-random bitstream is distributed in equal proportions to each of the at least two of the n further pseudo-random bitstreams.

54. A process as claimed in claim 51, in which at least two of the n further pseudo-random bitstreams are generated by distributing some separate part of the bit width of the first pseudo-random bitstream to each of the at least two of the n further pseudo-random bitstreams.

55. A process as claimed in claim 49, in which at least one of the FIFO buffers outputs a bitstream which is of a bit-width which is different from the width of the input bitstream to it.

56. A process as claimed in claim 49, in which at least one, but fewer than n, of the n further pseudo-random bitstreams is identical to the first pseudo-random bitstream.

57. Apparatus for encoding n inputs, the n inputs comprising:
at least one ingress input; and
at least one egress input,
the apparatus comprising:
a pseudo-random number generator (PRNG);
a bit-stream generator which takes the output of the PRNG as its input and which generates n further pseudo-random bitstreams as its outputs;
(n−1) FIFO buffers, each of which (n−1) FIFO buffers takes as its input one of the (n−1) further pseudo-random bitstreams and which releases stored data as output on demand;
n encoders, each of which encodes one of the n inputs and which uses in the process of encoding:
for each of (n−1) of the inputs, output from a unique one of the (n−1) FIFO buffers; and
for one of the inputs other than the (n−1) inputs, a pseudo-random bitstream which is:
either the n^{th} further pseudo-random bitstream; or
the output of an n^{th} FIFO buffer, the input to which is the n^{th} further pseudo-random bitstream.

58. Apparatus as claimed in claim 57, in which n is greater than 2.

59. Apparatus as claimed in claim 57, in which the output of the PRNG is at least two bits wide.

60. Apparatus as claimed in claim 57, in which at least two of the n further pseudo-random bitstreams is generated by sequentially distributing the first pseudo-random bitstream sequentially to each of the at least two of the n further pseudo-random bitstreams.

61. Apparatus as claimed in claim 60, in which the first pseudo-random bitstream is distributed in equal proportion to each of the at least two of the n further pseudo-random bitstreams.

62. Apparatus as claimed in claim 59, in which at least two of the n further pseudo-random bitstreams is generated by distributing some separate part of the bit width of the first pseudo-random bitstream to each of the at least two of the n further pseudo-random bitstreams.

63. Apparatus as claimed in claim 57, in which at least one of the FIFO buffers outputs a bitstream which is of a bit-width which is different from the width of the input bitstream to it.

64. Apparatus as claimed in claim 57, in which at least one, but fewer than n, of the n further pseudo-random bitstreams is identical to the first pseudo-random bitstream.
